(19) United States
(12) Patent Application Publication
(10) Pub. No.: US 2007/0182329 A1
(43) Pub. Date: Aug. 9, 2007

(54) Plasma display panel and method of manufacturing the same

(75) Inventors: Bo Hyun Kim, Suwon-si (KR); Min Soo Park, Seoul (KR); Deok Hai Park, Daegu (KR); Byung Gil Ryu, Seoul (KR); Young Sung Kim, Yongin-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/651,073

(22) Filed: Jan. 9, 2007

(30) Foreign Application Priority Data
Jan. 9, 2006 (KR) 10-2006-0002212
Jan. 11, 2006 (KR) 10-2006-0003193

(51) Int. Cl. H01J 17/49

(52) U.S. Cl. 313/583; 313/582; 313/584; 313/586; 313/587

(57) ABSTRACT

A plasma display panel having improved luminous efficiency is disclosed. The plasma display panel according to an embodiment of the present invention includes a first panel and a second panel. The first panel has an ultraviolet (UV) reflecting layer formed therein.

### CROSS-REFERENCE TO RELATED APPLICATION

This application claims the priority benefit of Korean Patent Application No. 10-2006-0002212 filed on Jan. 9, 2006 and Korean Patent Application No. 10-2006-0003193 filed on Jan. 11, 2006, which are hereby incorporated by reference in its entirety as if fully set forth herein.

### BACKGROUND OF THE INVENTION

1. Field of the Invention

The present invention relates to a plasma display panel, and more particularly, to improvement of the luminous efficiency of a plasma display panel.

2. Discussion of the Related Art

Generally, a plasma display panel comprises an upper panel, a lower panel, and barrier ribs formed between the upper and lower panels to define respective discharge cells. The respective discharge cells are filled with a major discharge gas, such as neon, helium, or a mixed gas of neon and helium, and with an inert gas containing a small amount of xenon (Xe). When a high-frequency voltage is applied to the plasma display panel such that discharge occurs in the respective discharge cells, vacuum ultraviolet rays are generated from the inert gas to cause phosphors present between the barrier ribs to emit light, and as a result, images are created. The plasma display panel with the above-stated structure has attracted more and more attention as the next-generation display device due to the small thickness and light weight thereof.

FIG. 1 is a perspective view schematically illustrating the structure of a plasma display panel according to a related art. As shown in FIG. 1, the plasma display panel comprises an upper panel 100 and a lower panel 110 integrally joined in parallel to and at a certain distance apart from the upper panel 100. The upper panel 100 includes an upper substrate 101 as a display plane on which images are displayed and a plurality of sustain electrode pairs, each pair consisting of a scan electrode 102 and a sustain electrode 103, arranged on the upper substrate 101. The lower panel 110 includes a lower substrate 111 and a plurality of address electrodes 113 arranged on the lower substrate 111 such that the plurality of address electrodes 113 are disposed generally perpendicular to the plurality of sustain electrode pairs.

Stripe type (or well type, etc.) barrier ribs 112 for forming a plurality of discharge spaces, i.e., discharge cells, are arranged in parallel with each other on the lower panel 110. A plurality of address electrodes 113, which generate vacuum ultraviolet rays due to address discharge, are arranged in parallel with the barrier ribs 112. Red (R), green (G), and blue (B) phosphors 114 are applied to the upper side of the lower panel 110 to emit visible rays at the time of address discharge, and, as a result, images are displayed. A lower dielectric layer 115 is formed between the address electrodes 113 and the phosphors 114 to protect the address electrodes 113.

An upper dielectric layer 104 is formed on the sustain electrode pairs 103, and a protective layer 105 is formed on the upper dielectric layer 104. The top surface of the upper dielectric layer 104 and the top surface of the protective layer 105 are flat or planar. The upper dielectric layer 104, which is included in the upper panel 100, however, is worn out due to the bombardment of positive (+) ions at the time of discharge of the plasma display panel. At this time, short circuits of the electrodes may be caused by metal elements such as sodium (Na). For this reason, a magnesium oxide (MgO) thin film as the protective layer 105 may be formed by coating to protect the upper dielectric layer 104.

However, the plasma display panel as described above according to the related art has the following problems and limitations.

Firstly, although the protective layer including magnesium oxide of the plasma display panel may sufficiently withstand the bombardment of positive (+) ions, the protective layer does not effectively lower the discharge voltage. This limitation is caused by the physical characteristics of magnesium oxide, which is a principal material for the protective layer. Specifically, this is because the magnesium oxide has a low secondary electron emission coefficient with respect to ions incident on the protective layer at the time of plasma discharge.

Secondly, the magnesium oxide improves the orientation, crystallinity, and density of the protective layer, and therefore, the magnesium oxide forms a highly sputtering-resistant protective layer. Also, the magnesium oxide exhibits relatively excellent electrical properties. However, the power consumption of the plasma display panel including the protective layer made of magnesium oxide still remains high. For this reason, there has been much research on a substitute for the magnesium oxide as a material for the protective layer, but there has not been yet proposed positively verified materials due to reliability problems thereof.

Thirdly, vacuum ultraviolet (VUV) rays are emitted from a discharge space in arbitrary directions at the time of discharge of the plasma display panel. As a result, the VUV rays advancing toward the protective layer of the upper panel do not reach the phosphors but are directed to the outside. Consequently, the luminous efficiency of the plasma display panel is lowered. This limitation then lowers the power usage efficiency of the plasma display panel and the display quality of the plasma display panel.

### SUMMARY OF THE INVENTION

Accordingly, the present invention is directed to a plasma display panel that substantially obviates or addresses one or more problems due to limitations and disadvantages of the related art.

An object of the present invention is to provide a plasma display panel having improved secondary electron emission characteristics, and thus, low firing voltage and low power consumption.

Another object of the present invention is to provide a plasma display panel and a method of forming the plasma display panel wherein the yield of VUV rays generated during the discharge is increased, whereby the brightness and the luminous efficiency of the plasma display panel are improved.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel according to an embodiment includes a first panel and a second panel, and the first panel has an ultraviolet (UV) reflecting layer formed thereon.

Preferably, the UV reflecting layer is made of a material selected from a group consisting of SiO₂, Al₂O₃, Gd₂O₃, TiO₂, and Y₂O₃.

Preferably, the UV reflecting layer is formed on the first panel as a protective layer, and the protective layer is a distributed brag reflector (DBR).

In another aspect of the present invention, a method of manufacturing a plasma display panel includes forming a dielectric layer on a sustain electrode pair formed on a first panel, forming a UV reflecting layer on the dielectric layer, and forming a protective layer on the UV reflecting layer.

In a further aspect of the present invention, a method of manufacturing a plasma display panel includes forming a dielectric layer on a sustain electrode pair formed on a first panel, and forming a protective layer constructed in a DBR structure on the dielectric layer.

According to another aspect, the present invention provides an upper panel structure for a plasma display panel device, comprising: a sustain electrode pair over a substrate; a dielectric layer over the sustain electrode pair; and an ultraviolet (UV) reflecting layer over the dielectric layer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a plasma display panel according to a related art;

FIG. 2 is a view illustrating a plasma display panel according to a first embodiment of the present invention;

FIG. 3 is a view illustrating a plasma display panel according to a second embodiment of the present invention;

FIG. 4 is a view illustrating a plasma display panel according to a third embodiment of the present invention;

FIG. 5 is a view illustrating a plasma display panel according to a fourth embodiment of the present invention;

FIG. 6 is a view illustrating the increase of reflexibility of the plasma display panel according to the present invention;

FIG. 7 is a view illustrating the increase of the luminous efficiency of the plasma display panel according to the present invention;

FIG. 8 is a view illustrating the structure of a distributed brag reflector (DBR);

FIG. 9 is a view illustrating a discharge cell structure of a plasma display panel according to a fifth embodiment of the present invention; and

FIG. 10 is a view illustrating an upper panel of the plasma display panel according to the fifth embodiment of the present invention as shown in FIG. 9.

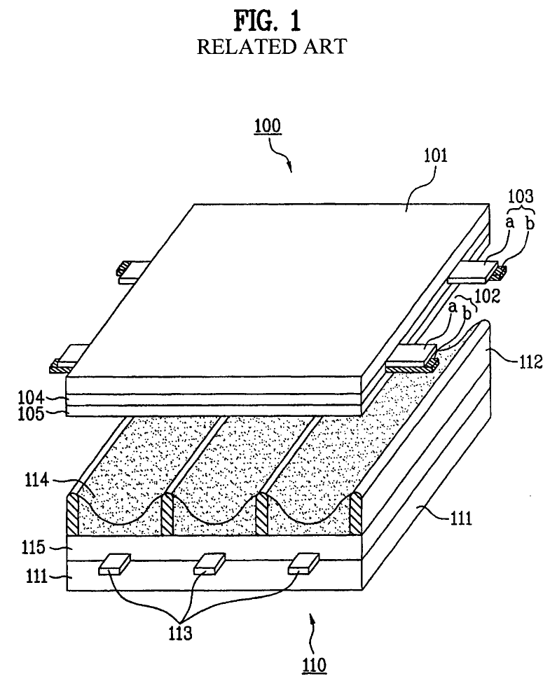

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

A plasma display panel according to an embodiment of the present invention includes a vacuum ultraviolet (VUV) reflecting layer formed in an upper panel of the plasma display panel. Specifically, VUV rays emitted from an inert gas at the time of discharge advance in arbitrary directions. As a result, the VUV rays advancing toward the upper panel do not reach phosphors and are directed to the outside. According to the present invention, however, the VUV reflecting layer is formed in the upper panel, and therefore, VUV rays advancing toward the upper panel at the time of discharge are reflected by the VUV reflecting layer such that the VUV rays can be directed toward the phosphors provided below the upper panel.

According to an embodiment of the present invention, it is required that the VUV reflecting layer be made of at least one metal oxide such as SiO₂, Al₂O₃, Gd₂O₃, TiO₂, or Y₂O₃. Magnesium oxide, which is a material for a related art protective layer, transmits VUV rays there through. In contrast, the material(s) constituting the VUV reflecting layer according to the present invention reflect ultraviolet (UV) rays and VUV rays. Consequently, the yield of VUV rays generated during the discharge is increased, whereby the brightness and the luminous efficiency of the plasma display panel are improved effectively. In addition, secondary electron emission is increased, and therefore, the discharge voltage of the plasma display panel is reduced, which lowers the power consumption of the plasma display panel. Also, according to an embodiment, it is sufficient or preferable that the VUV reflecting layer has a thickness of 1 μm to 3 μm so as to improve the secondary electron emission effect of the plasma display panel.

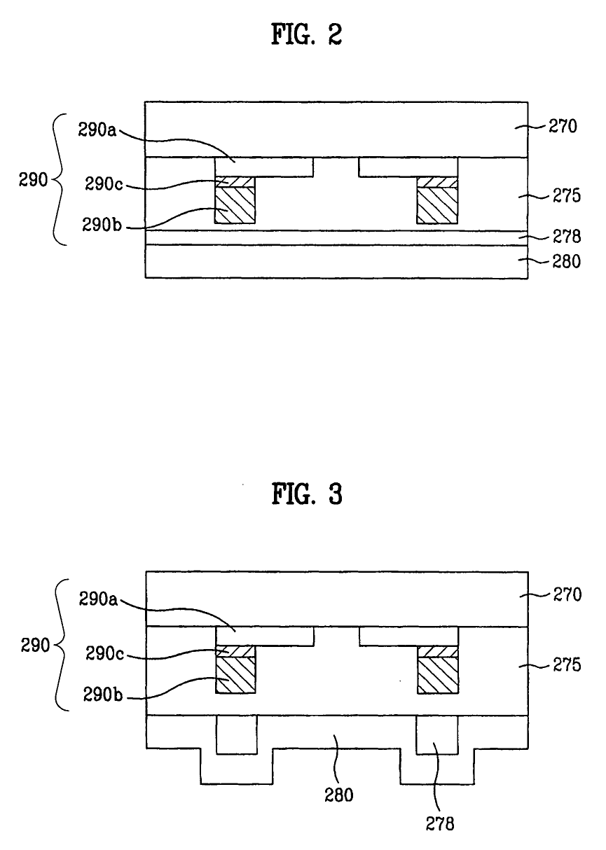

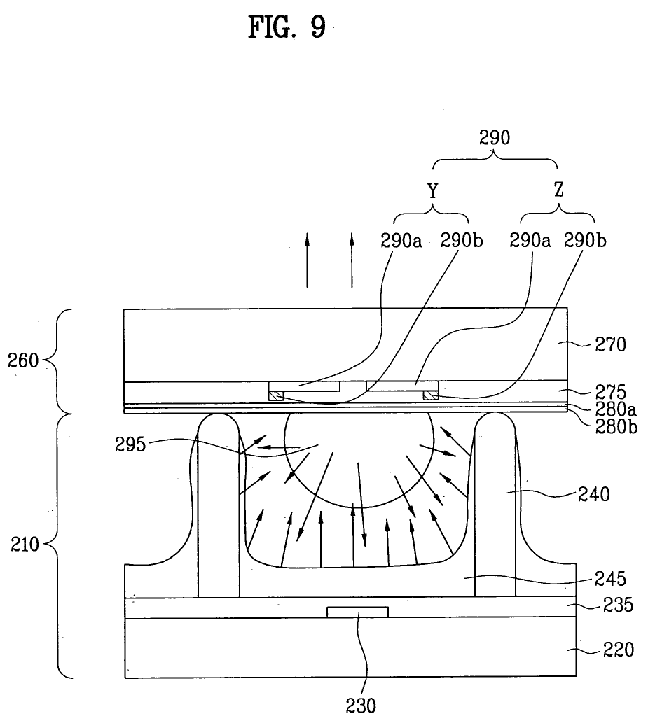

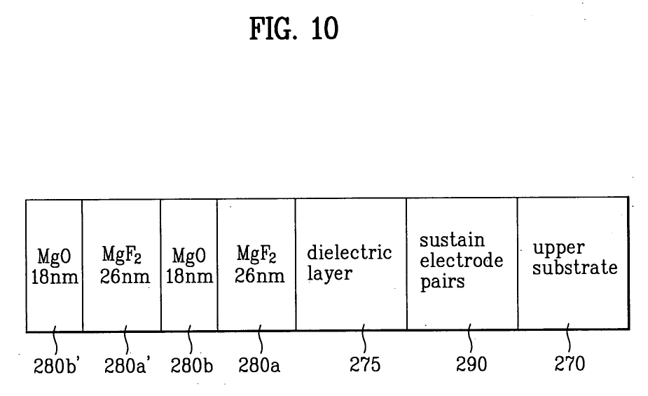

FIG. 2 is a view illustrating a plasma display panel according to a first embodiment of the present invention. Particularly, the upper panel of the plasma display panel is shown, but the plasma display panel includes other components including the lower panel, barrier ribs, phosphors, etc. The lower panel can have the structure as shown in FIG. 9.

As shown in FIG. 2, the upper panel of the plasma display panel includes one or more sustain electrode pairs 290 (290a, 290b) formed on an upper substrate 270, an upper dielectric layer 275 formed on the sustain electrode pair(s) 290, and a protective layer 280 formed on the upper dielectric layer 275. Each sustain electrode pair 290 includes a transparent electrode 290a and a bus electrode 290b on the transparent electrode 290a. Optionally, a black electrode 290c may be interposed between the transparent electrode 290a and the bus electrode 290b. In fact, in all embodiments (e.g., FIGS. 2-10) described herein, the bus electrode 290b may be formed directly on the transparent electrode 290a, or the black electrode 290c may be disposed between the transparent electrode 290a and bus electrode 290b.

Furthermore, the upper panel of the plasma display panel includes a VUV reflecting layer 278 is formed between the upper dielectric layer 275 and the protective layer 280. Specifically, the protective layer 280 is formed at the side of the upper dielectric layer 275 contacting a discharge space so as to protect the dielectric layer from the bombardment of positive (+) ions. The VUV reflecting layer 278 is provided to reflect VUV rays at the time of discharge, so as to redirect the VUV rays toward the phosphors (e.g., 245 in FIG. 9) below the upper panel to improve the luminous efficiency of the plasma display panel. Preferably, the VUV reflecting layer 278 here and in other embodiments is made of at least one metal oxide such as SiO₂, Al₂O₃, Gd₂O₃, TiO₂, or Y₂O₃. Also, the VUV reflecting layer 278 here and in other embodiments can have a thickness of approximately 1 μm to 3 μm.

FIGS. 3 to 5 are views illustrating plasma display panels respectively according to second, third, and fourth embodiments of the present invention. Particularly, in each of FIGS. 3 to 5, the upper panel of the plasma display panel is shown, but the plasma display panel includes other components including the lower panel, barrier ribs, phosphors, etc. The lower panel can have the structure as shown in FIG. 9.

In the embodiments shown in FIGS. 3 to 5, the VUV reflecting layer 278 is partially formed on the upper dielectric layer 275 in a pattern, instead of covering the entire (or substantial part thereof) surface of the upper dielectric layer 275 in a planar manner. For instance, a pattern of the VUV reflecting layer 278 is formed on the upper dielectric layer 275, and this pattern may be aligned with a portion of the sustain electrode pair. According to these embodiments, the secondary electron emission effect is improved due to the function of the VUV reflecting layer as described above. In addition, the side of the upper dielectric layer contacting the discharge space is constructed in a concave-convex structure due to the VUV reflecting layer 278, and therefore, the surface area of the upper dielectric layer including the VUV reflecting layer is increased. Consequently, the emission of secondary electrons is further increased, and therefore, the firing voltage and the power consumption of the plasma display panel are reduced.

Referring to FIG. 3, according to the second embodiment, the VUV reflecting layer 278 is formed on the upper dielectric layer 275 at positions corresponding to the bus electrodes 290b. For instance, the VUV reflecting layer 278 in the form of projections is formed on the dielectric layer 275, and the projections (VUV reflecting layer 278) are aligned or substantially aligned with the bus electrodes 290b as shown.

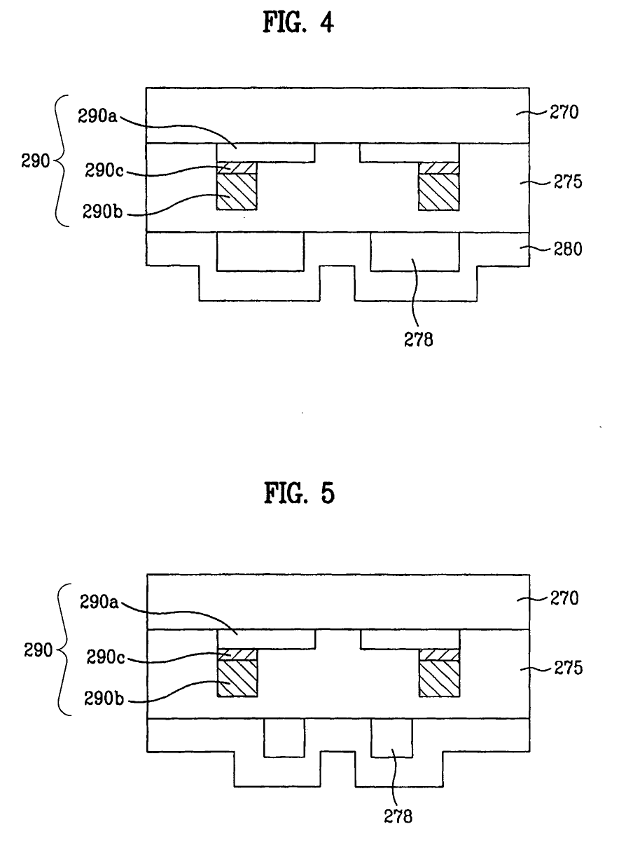

Referring to FIG. 4, according to the third embodiment, the VUV reflecting layer 278 is formed on the upper dielectric layer 275 at positions corresponding to transparent electrodes 290a. For instance, the VUV reflecting layer 278 in the form of projections is formed on the dielectric layer 275, and the projections (VUV reflecting layer 278) are aligned or substantially aligned with the transparent electrodes 290a as shown.

Referring to FIG. 5, according to the fourth embodiment, the VUV reflecting layer 278 is formed on the upper dielectric layer 275 at positions corresponding to regions of the transparent electrodes 290a on which the bus electrodes 290a are not formed. For instance, the VUV reflecting layer 278 in the form of projections is formed on the dielectric layer 275, and the projections (VUV reflecting layer 278) are aligned or substantially aligned with portions of the transparent electrodes 290a on which the bus electrodes 290b are not formed, as shown.

As shown in FIGS. 3 to 5, the protective layer 280 is formed, with a predetermined thickness, on the VUV reflecting layer 278 partially formed on the upper dielectric layer 275, and therefore, the protective layer 280 is constructed in a concave-convex structure due to the VUV reflecting layer 278 projecting from the dielectric layer 278. Also, the VUV reflecting layer 278 in FIGS. 3 to 5 preferably extends along with and in the same direction as the transparent electrodes 290a or bus electrodes 290b.

The present invention encompasses variations of the structures of the VUV reflecting layer 278 of FIGS. 3-5. For instance, the VUV reflecting layer 278 in the form of projections may not be aligned with the sustain electrode pair 290, but may just be disposed above the sustain electrode pair 290 or above the upper dielectric layer 275, in different patterns. As a variation, a combination of the planar VUV reflecting layer 278 in FIG. 2 and the projecting VUV reflecting layer 278 in any of FIGS. 3 to 5 can also be used. For instance, in the upper panel of FIG. 2, projections (VUV reflecting material) can be formed at the VUV reflecting layer 278 to correspond with the sustain electrode pair 290. Also, the projections (VUV reflecting layer 278) of FIGS. 3-5 may have different shapes than what is shown, e.g., they may have triangular or semi-oval type shapes.

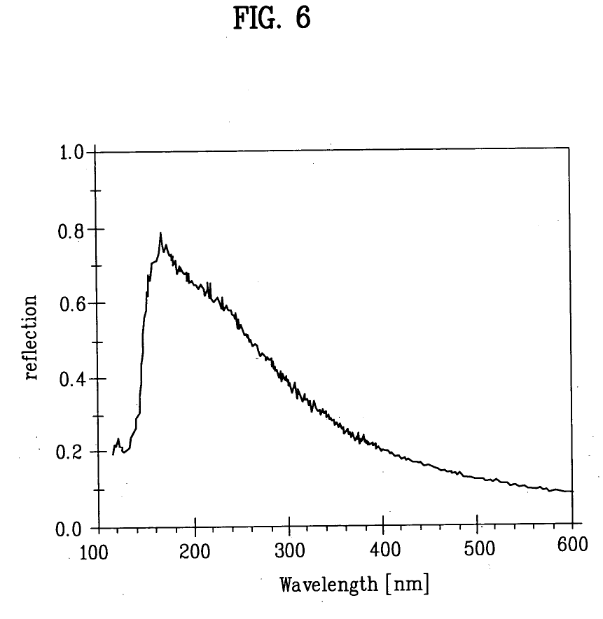

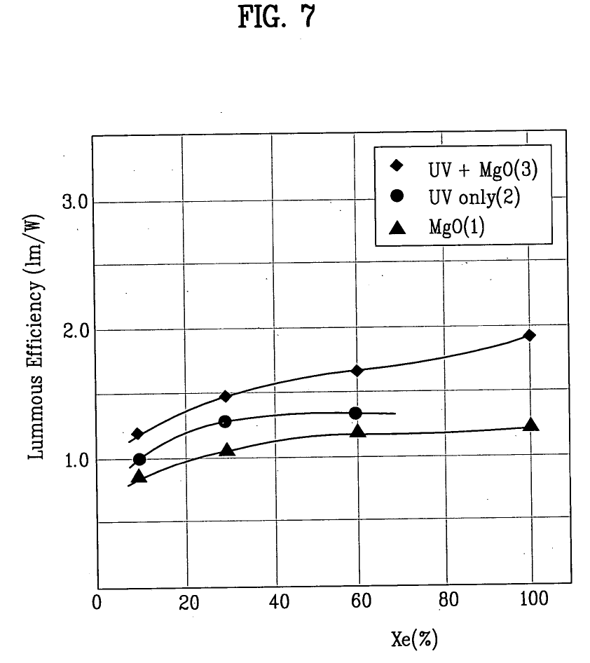

FIG. 6 is a view illustrating the increase of reflexibility of the plasma display panel according to the present invention, and FIG. 7 is a view illustrating the increase of the luminous efficiency of the plasma display panel according to the present invention. Hereinafter, the operation of the plasma display panel with the above-stated (and below-stated) constructions according to the present invention will be described in detail with reference to FIGS. 6 and 7.

FIG. 6 is a graph showing the increase of reflexibility of a VUV reflecting layer when the VUV reflecting layer, made of SiO₂ as an example, is formed with a thickness of 3 μm. As can be seen from FIG. 6, in this example, the reflexibility of the VUV reflecting layer is at a maximum at a wavelength of approximately 170 nm, and the reflexibility of the VUV reflecting layer is greatly increased at a wavelength of approximately 147 nm.

FIG. 7 is a graph showing the increase of the luminous efficiency of the plasma display panel when the VUV reflecting layer is included in the plasma display panel according to the present invention. In the example of FIG. 7, a curve indicated by ▴ is obtained when only the protective layer made of magnesium oxide is used (related art) (case 1), a curve indicated by • is obtained when only the VUV reflecting layer is used (case 2), and a curve indicated by ♦ is obtained when both the protective layer made of magnesium oxide and the VUV reflecting layer are used (case 3).

As can be seen from FIG. 7, the luminous efficiency of the plasma display panel is higher for the case (1) where only the VUV reflecting layer is used than for the case (2) where only the protective layer made of magnesium oxide is used. Also, it can be seen that the luminous efficiency of the plasma display panel is the highest in the case (3) where both the protective layer made of magnesium oxide and the VUV reflecting layer are used. The present invention encompasses the case (2) where the VUV reflecting layer without the protective layer may be provided in the upper panel of the plasma display panel. However, preferably, the present invention provides both the VUV reflecting layer and the protective layer on the upper dielectric layer in the upper panel of the plasma display panel as discussed in connection with FIGS. 2-5.

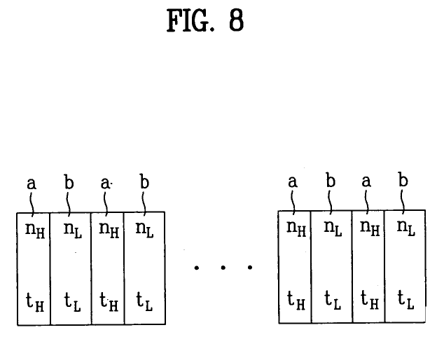

FIG. 8 is a view illustrating an example of the structure of a distributed brag reflector (DBR), FIG. 9 is a view illustrating a discharge cell structure of a plasma display panel according to a fifth embodiment of the present invention, and FIG. 10 is a view illustrating an upper panel of the plasma display panel according to the fifth embodiment of the present invention as shown in FIG. 9. Hereinafter, the plasma display panel according to the fifth embodiment of the present invention will be described in detail.

In this embodiment, the VUV reflecting layer is formed on the upper panel as a protective layer, and the protective layer is constructed in a DBR structure to increase the VUV reflexibility of the plasma display panel.

As shown in FIG. 8, the DBR is formed by joining at least one ‘a’ layer made of a material H having a high refractive index (nH) and at least one ‘b’ layer made of a material L having a low refractive index (n_{L}). Preferably, a plurality of the ‘a’ layers and ‘b’ layers are alternately arranged to form the DBR, although only one ‘a’ layer and only one ‘b’ layer can be used to form the DBR. In FIG. 8, the refractive index and the thickness of each ‘a’ layer are indicated by n_{H} and t_{H}, and the refractive index and the thickness of each ‘b’ layer are indicated by n_{L} and t_{L}. When the wavelength of light incident on the DBR is indicated by λ, the thickness t_{H} of each ‘a’ layer having the high refractive index is expressed by the following equation:

$${t}_{H} = \frac{λ}{4 {n}_{H}} \qquad [ Equation 1 ]$$

On the other hand, the thickness t_{L} of each ‘b’ layer having the low refractive index is expressed by the following equation:

$${t}_{L} = \frac{λ}{4 {n}_{L}} \qquad [ Equation 2 ]$$

The reflexibility of the DBR is expressed by Equation 3. Consequently, the reflexibility of the DBR is increased as the difference between the refractive indices is increased. Also, since light is reflected at the interfaces between the respective ‘a’ and ‘b’ layers of the DBR, the reflexibility R of the DBR is increased as the number of the layers is increased.

$$R = {( \frac{( {n}_{1} - {n}_{2} )}{( {n}_{1} + {n}_{2} )} )}^{2} \qquad [ Equation 3 ]$$

When light having a wavelength λ is incident on the reflecting layer of the DBR structure with the above-stated construction, the phase differences of light reflected at the interfaces between the ‘a’ and ‘b’ layers coincide with each other, and therefore, the reflexibility of the DBR structure is increased.

In this embodiment, the protective layer is constructed in the above-described DBR structure. Consequently, as shown in FIG. 9, the protective layer in the upper panel of the plasma display panel includes at least one pair of two layers 280a and 280b made of different refractive indices. For instance, the protective layer (280) includes a second protective layer 280b made of magnesium oxide, and a first protective layer 280a made of a material having a refractive index different from (lower or higher than) that of the magnesium oxide of the second protective layer 280b, which form a pair. The magnesium oxide in the second protective layer 280b improves the orientation, crystallinity, and density of the protective layer, and therefore, the magnesium oxide is suitable to form a highly sputtering-resistant protective layer. Also, the magnesium oxide exhibits relatively excellent electrical properties, and therefore, the magnesium oxide is suitable as the second protective layer 280b at the side of the upper dielectric layer 275 contacting the discharge space so as to protect the upper dielectric layer 275. The first protective layer 280a is made of a material having a refractive index higher or lower than that of the magnesium oxide. The refractive index of the magnesium oxide is 1.65 to 1.82 for a wavelength of 200 to 800 nm and approximately 2 for a wavelength of VUV rays.

As an example, if the material constituting the first protective layer 280a is metal, it is required for the first protective layer 280a to be very thin because the metal has high light absorptivity. Also, it is required for the first protective layer 280a to serve to accumulate electric charges. Consequently, the first protective layer 280a is preferably made of a dielectric material. Specifically, the first protective layer 280a may be made of ZrO₂, TiO₂, ZnS, chromium oxide, copper oxide, or diamond, which has a refractive index higher than that of the magnesium oxide of the second protective layer 280b. Alternatively, the first protective layer 280a may be made of cryolite, MgF₂, CeF₂, or flourite, which has a refractive index lower than that of the magnesium oxide of the second protective layer 280b. The specified materials have the following refractive indices in the VUV region: ZrO₂=2.1, TiO₂=2.4, ZnS=2.32, chromium oxide=2.7, copper oxide=2.7, diamond=2.4, cryolite=1.35, MgF₂=1.38, CeF₂=1.63, and flourite=1.434.

According to the present invention, any number of first and second protective layer pairs may be provided on the upper dielectric layer 275 in the upper panel of the plasma display panel. For instance, referring to FIG. 10, two pairs of first and second protective layers are formed. Specifically, a first protective layer 280a made of MgF₂ and a second protective layer 280b made of magnesium oxide are sequentially formed on the dielectric layer 275 in the upper panel of the plasma display panel. Also, an additional first protective layer 280a′ made of MgF₂ and an additional second protective layer 280b′ made of magnesium oxide are sequentially formed on the second protective layer 280b. MgF₂ constituting the first protective layers 280a and 280a′ has a refractive index of approximately 1.38. Consequently, it is preferable that the first protective layers 280a and 280a′ has a thickness of approximately 26 nm so as to reflect VUV rays having a wavelength of 147 nm (147 nm/(4×1.38)=approximately 26 nm).

Also, Magnesium oxide constituting the second protective layers 280b and 280b′ has a refractive index of approximately 2. Consequently, it is preferable that the second protective layers 280b and 280b′ has a thickness of approximately 18 nm so as to reflect VUV rays having a wavelength of 147 nm (147 nm/(4×2)=approximately 18 nm). When it is needed to reflect UV rays having a wavelength of 172 nm, it is possible to change the thickness of the respective protective layers according to the aforesaid equations.

In the fifth embodiment, the outer construction of the plasma display panel excluding the protective layers is identical to that of the conventional plasma display panel or that as shown in FIG. 9. Specifically, a three-electrode alternating current surface discharge type plasma display panel is constructed to have a structure in which an upper panel 260 and a lower panel 210 are joined with each other while barrier ribs 240 are disposed between the upper panel 260 and the lower panel 210. The lower panel 210 is constructed to have a structure in which one or more address electrodes 230 are formed on a lower substrate 220, and a lower dielectric layer 235 is formed on the lower substrate 220 and the address electrode(s) 230. Each address electrode 230 is formed in each discharge cell provided between two adjacent barrier ribs 240. The barrier ribs 240 are formed on the lower dielectric layer 235. Neighboring discharge cells are separated from each other by the barrier ribs 240. In this example, a phosphor 245 is applied to the side surfaces of the barrier ribs 240 and the lower dielectric layer 235.

The upper panel 260 is constructed to have a structure in which one or more sustain electrode pairs 290 are formed on an upper substrate 270, wherein the sustain electrodes 290Y and 290Z in the sustain electrode pair 290 are spaced a predetermined distance from each other. The sustain electrode pairs 290 cross perpendicularly over the address electrodes 230 and extend laterally. Each sustain electrode includes a transparent electrode 290a and a bus electrode 290b formed on the transparent electrode 290a. The transparent electrodes 290a have low conductivity. For this reason, the bus electrodes 290b are further provided to reduce the resistance of the sustain electrode pair 290Y and 290Z. On the upper substrate 270 and the sustain electrode pair 290, there is formed the upper dielectric layer 275. On the upper dielectric layer 275, there are sequentially formed the first protective layer 280a and the second protective layer 280b as discussed above.

The lower panel 210 and the upper panel 260 of the plasma display panel are joined to each other, while being opposite to each other, so as to define discharge cells. Between the sustain electrode pairs 290 or at the top of the barrier ribs 240, there is disposed a black matrix or a black top for absorbing external light introduced into the discharge cells such that the external light is not reflected. Each discharge cell defined by the upper panel 260, the lower panel 210, and the barrier ribs 240 is filled with a discharge gas. The discharge gas is an inert gas, for example, a mixed gas of helium and xenon (He+Xe), a mixed gas of neon and xenon (Ne+Xe), or a mixed gas of helium, neon, and xenon (He+Ne+Xe).

As a variation, both the reflective layer 278 as discussed in the first to fourth embodiments and the multiple protective layers 280 as discussed in the fifth embodiment may be provided in the upper panel of the plasma display panel according to the present invention.

Hereinafter, the operation of the plasma display panel according to the fifth embodiment of the present invention will be described.

VUV rays generated from a discharge gas at the time of discharge of the plasma display panel are emitted from the discharge space in arbitrary directions. At this time, the VUV rays are reflected by the protective layers 280a and 280b (or 280a, 280b, 280a′, 280b′, etc.) of the upper panel, which are constructed in a DBR structure, and are then directed toward the discharge space. As a result, the phosphor 245 emits light, whereby visible rays are emitted. Consequently, the brightness and the luminous efficiency of the plasma display panel are improved. Also, the VUV reflexibility is increased when the difference between the refractive index of the first protective layer 280a and the refractive index of the second protective layer 280b is large, and the first and second protective layer pairs are provided in large numbers, as described above.

Hereinafter, a method of manufacturing the plasma display panel with the above-stated constructions according to the first to fourth embodiments of the present invention will be described.

First, glass, which is a raw material for an upper substrate, is processed, and transparent electrodes and bus electrodes are sequentially formed on the upper substrate so as to constitute one or more sustain electrode pairs. Subsequently, an upper dielectric layer is formed on the upper substrate and the sustain electrode pair(s) by a drying and sintering process, and then a VUV reflecting layer and a protective layer are sequentially formed on the upper dielectric layer. The VUV reflecting layer may be formed using a conventional method of forming an upper dielectric layer and a protective layer. Preferably, the VUV reflecting layer is formed using a vacuum depositing method such as an electron beam depositing method, a sputtering method, or an ion-plating method. The composition, the thickness, and the location of the VUV reflecting layer can be as discussed above in the first to fourth embodiments. In the plasma display panels according to second to fourth embodiments of the present invention, the VUV reflecting layer is only partially formed on the upper dielectric layer. Consequently, in those cases, it is preferable to form the VUV reflecting layer, for example, by patterning.

Hereinafter, a method of manufacturing the plasma display panel with the above-stated construction according to the fifth embodiment of the present invention will be described. This fifth embodiment is characterized in that the protective layers are constructed in a DBR structure. First, one or more sustain electrode pairs and a dielectric layer are sequentially formed on an upper substrate. Next, protective layers for reflecting VUV rays are formed on the dielectric layer. In order that the protective layers are constructed in the DBR structure, a first protective layer is formed on the dielectric layer with a material having a refractive index higher or lower than that of magnesium oxide, and then a second protective layer is formed on the first protective layer with magnesium oxide. Preferably, the first and second protective layers are formed in the entire discharge space. More preferably, the first and second protective layers are formed by a screen printing method or formed in a vacuum atmosphere by a sputtering method, an ion-plating method, or an electron beam depositing method. If a plurality of protective layers are to be formed as described above, additional first and second protective layers can be repeatedly formed on the second protective layer made of magnesium oxide in sequence.

Although the present invention has been discussed above to provide the VUV reflecting layer(s) and/or to be concerned with reflecting VUV rays (e.g., using protective layer(s)) according to embodiments thereof, the present invention is not limited thereto and encompasses having the same or similar reflecting layer(s) or protective layer(s) to reflect UV rays or other types of rays in connection with display devices such as plasma display panels.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising:
a first panel and a second panel coupled to the first panel with a certain distance therebetween,
wherein the first panel has an ultraviolet (UV) reflecting layer formed therein.

2. The plasma display panel according to claim 1, wherein the first panel further includes a dielectric layer and a protective layer, and the UV reflecting layer is disposed between the dielectric layer and the protective layer.

3. The plasma display panel according to claim 2, wherein the UV reflecting layer is partially formed on the dielectric layer.

4. The plasma display panel according to claim 3, wherein the first panel further includes transparent electrodes, and the UV reflecting layer is disposed at positions corresponding to the transparent electrodes.

5. The plasma display panel according to claim 3, wherein the first panel further includes bus electrodes and the UV reflecting layer is disposed at positions corresponding to the bus electrodes.

6. The plasma display panel according to claim 3, wherein the first panel further includes transparent electrodes and bus electrodes formed on the transparent electrodes, and the UV reflecting layer is disposed at positions corresponding to regions of the transparent electrodes where the bus electrodes are not formed.

7. The plasma display panel according to claim 1, wherein the UV reflecting layer is made of a material selected from a group consisting of SiO₂, Al₂O₃, Gd₂O₃, TiO₂, and Y₂O₃.

8. The plasma display panel according to claim 1, wherein the UV reflecting layer has a thickness of approximately 1 μm to 3 μm.

9. The plasma display panel according to claim 1, wherein the first panel further includes a dielectric layer, and the UV reflecting layer is formed on the dielectric layer as a protective layer.

10. The plasma display panel according to claim 9, wherein the protective layer is a distributed brag reflector (DBR).

11. The plasma display panel according to claim 10, wherein the DBR includes at least one pair of a thin magnesium oxide film and a thin film made of a material having a refractive index different from that of magnesium oxide in the thin magnesium oxide film.

12. The plasma display panel according to claim 10, wherein the DBR includes a thin magnesium oxide film having a refractive index of n₁ and a thin film having a refractive index of n₂, and
wherein the thin magnesium oxide film having the refractive index of n₁ has a thickness of λ/4n₁, and the thin film having the refractive index of n₂ has a thickness of λ/4n₂.

13. The plasma display panel according to claim 12, wherein the thin film having the refractive index of n₂ is made of a material selected from a group consisting of ZrO₂, TiO₂, ZnS, chromium oxide, copper oxide, diamond, cryolite, MgF₂, CeF₂, and fluorite.

14. The plasma display panel according to claim 12, wherein the λ is 147 nm.

15. The plasma display panel according to claim 1, wherein the UV reflecting layer is a vacuum ultraviolet (VUV) reflecting layer.

16. A method of manufacturing a plasma display panel, comprising:
forming a dielectric layer on at least one sustain electrode pair of a first panel;
forming an ultraviolet (UV) reflecting layer on the dielectric layer; and
forming a protective layer on the UV reflecting layer.

17. The method according to claim 16, wherein the step of forming the UV reflecting layer is carried out with a material selected from a group consisting of SiO₂, Al₂O₃, Gd₂O₃, TiO₂, and Y₂O₃ using an electron beam depositing method, a sputtering method, or an ion-plating method.

18. The method according to claim 16, wherein the UV reflecting layer covers substantially the dielectric layer.

19. The method according to claim 16, wherein the UV reflecting layer has a pattern corresponding to at least a portion of the at least one sustain electrode pair.

20. The method according to claim 16, further comprising:
forming a second panel including a plurality of address electrodes; and
forming barriers ribs and phosphors between the first and second panels.

21. The method according to claim 16, wherein the UV reflecting layer is a vacuum ultraviolet (VUV) reflecting layer.

22. A method of manufacturing a plasma display panel, comprising:
forming a dielectric layer on at least one sustain electrode pair of a first panel; and
forming a protective layer constructed in a distributed brag reflector (DBR) structure on the dielectric layer.

23. The method according to claim 22, wherein the step of forming the protective layer is carried out using a screen printing method, a sputtering method, an ion-plating method, or an electron beam depositing method.

24. The method according to claim 22, wherein the step of forming the protective layer includes sequentially forming a first layer made of magnesium oxide and having a refractive index of n₁ and a thickness of λ/4n₁, and a second layer made of a material having a refractive index n₂ different from that of the magnesium oxide and having a thickness of λ/4n₂.

25. The method according to claim 24, wherein the material having the refractive index n₂ different from that of the magnesium oxide is selected from a group consisting of ZrO₂, TiO₂, ZnS, chromium oxide, copper oxide, diamond, cryolite, MgF₂, CeF₂, and fluorite.

26. The method according to claim 22, wherein the step of forming the protective layer includes sequentially forming a plurality of protective layer pairs on the dielectric layer, and each protective layer pair includes a first layer made of magnesium oxide and having a refractive index of n₁ and a thickness of λ/4n₁ and a second layer made of a material having a refractive index n₂ different from that of the magnesium oxide and having a thickness of λ/4n₂.

27. The method according to claim 22, further comprising:
forming a second panel including a plurality of address electrodes; and
forming barriers ribs and phosphors between the first and second panels.

28. An upper panel structure for a plasma display panel device, comprising:
a sustain electrode pair over a substrate;
a dielectric layer over the sustain electrode pair; and
an ultraviolet (UV) reflecting layer over the dielectric layer.

29. The upper panel structure according to claim 28, wherein the UV reflecting layer covers a substantial part of the dielectric layer.

30. The upper panel structure according to claim 28, wherein the sustain electrode pair includes transparent electrodes on the substrate, and bus electrodes on the transparent electrodes, and
the UV reflecting layer is aligned substantially with the transparent electrodes, the bus electrodes, or portions of the transparent electrodes on which the bus electrodes are not formed.

31. The upper panel structure according to claim 28, further comprising:
at least one protective layer on the UV reflecting layer.

32. The upper panel structure according to claim 28, wherein the UV reflecting layer functions as a protective layer.

33. The upper panel structure according to claim 32, wherein the UV reflecting layer as the protective layer over the dielectric layer has a distributed brag reflector (DBR) structure.

34. The upper panel structure according to claim 32, wherein the UV reflecting layer as the protective layer over the dielectric layer includes at least one protective layer pair, each pair including a first layer made of magnesium oxide and having a refractive index of n_{1 and a thickness of λ/}4n₁, and a second layer made of a material having a refractive index n₂ different from that of the magnesium oxide and having a thickness of λ/4n₂.

35. The upper panel structure according to claim 28, wherein the UV reflecting layer is a vacuum ultraviolet (VUV) reflecting layer.
